(19) United States
(12) Patent Application Publication
(10) Pub. No.: US 2011/0026581 A1
(43) Pub. Date: Feb. 3, 2011

(54) Scalable Coding with Partial Eror Protection

(75) Inventors: Pasi Sakari Ojala, Kirkkonummi (FI); Miska Matias Hannuksela, Ruutana (FI); Ari Kalevi Lakaniemi, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/738,582

(22) PCT Filed: Oct. 16, 2007
(86) PCT No.: PCT/EP07/61031

§ 371 Date: Jul. 27, 2010

(51) Int. Cl. H04B 1/66

(52) U.S. Cl. 375/240

(57) ABSTRACT

An encoder for encoding an audio signal, wherein the encoder comprises: a first encoder configured to receive an first signal and generate a second signal dependent on the first signal; a second encoder configured to generate a third signal dependent on the second signal and the first signal; a signal processor configured to partition the third signal into at least two parts; and a multiplexer configured to receive the at least two parts of the third signal and the second signal and combine the said signals to output an encoded signal.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, it may code with good quality any signal including music, background noise and speech.

A further audio and speech coding option is an embedded variable rate speech or audio coding scheme, which is also referred as a layered coding scheme. Embedded variable rate audio or speech coding denotes an audio or speech coding scheme, in which a bit stream resulting from the coding operation is distributed into successive layers. A base or core layer which comprises a primary coded data generated by a core encoder is formed of the binary elements essential for the decoding of the binary stream, and determines a minimum quality of decoding. Subsequent layers make it possible to progressively improve the quality of the signal arising from the decoding operation, where each new layer brings new information. One of the particular features of layered based coding is the possibility of intervening at any level whatsoever of the transmission or storage chain, so as to delete a part of binary stream without having to include any particular indication to the decoder.

By the very nature of layered, or scalable, based coding schemes the structure of the codecs tends to be hierarchical in form, consisting of multiple coding stages. Some codecs adopt an approach of using different coding techniques for both the core (or base) layer and additional (or higher) layers. Whereas, other structures of scalable codecs may adopt the approach of using the same coding techniques for both core and additional layers. Additional (or higher) layer coding is typically used to either code those parts of the signal which have not been coded by previous layers, or to code a residual signal from the previous stage. The residual signal is formed by subtracting a synthetic signal i.e. a signal generated as a result of the previous stage from the original. By adopting this hierarchical approach a combination of coding methods make it possible to reduce the output to relatively low bit rates but retaining sufficient quality, whilst also producing good quality audio and speech reproduction by using higher bit rates.

Speech and audio codecs based on the Code Excited Linear Prediction (CELP) algorithm, include many variants of which the following is a non limiting list: Adaptive multi-rate narrow band (AMR-NB), Adaptive multi-rate wide band (AMR-WB) and the source controlled VMR-WB codec. These codecs can be referred to as hybrid codecs, that is they are a hybrid of parametric and waveform coding techniques. Typically, they contain a parametric speech production model and waveform coding stage which is used to code the residual signal.

Details of the AMR codec can be found in the 3GPP TS 26.090 technical specification, the AMR-WB codec 3GPP TS 26.190 technical specification, and the AMR-WB+ in the 3GPP TS 26.290 technical specification. Details on the VMR-WB codec can be found in the 3GPP2 technical specification C.S0052-0.

These codecs can be employed in Voice over IP (VoIP) applications operating over packet switched network transmission protocols. Typically employed protocols are the Real-time Transport Protocol (RIP) encapsulated in the User Datagram Protocol (UDP), further encapsulated into Internet Protocol (IP). The checksums employed in the UDP and IP result in discarding all the packets in which the receiver detects bit errors. That is, the protocol stack does not convey any distorted packets to the application layer. Hence, when the IP packets are transmitted over an error prone radio link or over any media introducing transmission errors, the application layer faces packet losses. On the other hand, none of the packets reaching the application layer contain any residual bit errors. Due to this phenomenon, the error concealment algorithm is not able to utilise partially correct frames, as can be done e.g. in the circuit switched GSM telephone service, but the erroneous frame needs to be completely replaced. This is likely to make the error concealment less effective than the approach used in circuit switched service.

Various methods have been introduced to combat the packet loss conditions. Methods include multiple description coding, in which the information is distributed over several IP packets, and application level forward error correction (FEC) schemes in which the error correcting code is used to reconstruct the lost packets.

One relatively simple approach that has been utilised to compensate for packet loss is redundant frame transmission. In this scheme redundant copies of previously transmitted frames are delivered together with new data to be used in the receiver in order to replace frames carried in packets that were lost during transmission. Such a method has a low computation requirement both in encoding and decoding, however this is at the expense of significantly increased bit rate. For example, the bandwidth requirement is doubled when one redundant frame is attached to each transmitted packet where each packet contains one primary speech frame. Furthermore, and more importantly, the system delay is increased since either the sender or the receiver needs to buffer speech frames for the duration covered by the redundancy. Thus the error correction efficiency of redundant transmission, i.e. repetition coding, does not achieve the level of efficiency achievable by true error correction coding.

It is known to be advantageous for robust reconstruction to protect the most important parameters with strong error protection and use weaker error protection for the remainder, a method known as the unequal error protection scheme. Typically, in circuit switched systems, the most sensitive bits of a speech codec are protected with stronger FEC scheme compared to the least sensitive bits. In addition, an error detection code such as CRC could be used to classify the whole frame as lost when the most sensitive bits contain errors.

Similarly packet switched systems such as IP transport mechanisms provide tools for generating and decoding FEC packets. For example IETF RFC 2733 provides a generic means to transport XOR-based forward error correction data within a separate RTP session. The payload header of FEC packets in this standard contain a bit mask identifying the packet payloads over which the bit-wise XOR operation is calculated and a few fields for RTP header recovery of the protected packets. One XOR FEC packet therefore enables recovery of one lost source packet. Furthermore development on a replacement for IETF RFC 2733 with similar RTP payload format for XOR-based FEC protection is in progress where a capability of uneven levels of protection has been discussed, herein referred to as the ULP Internet Draft [A. H. Li, “RTP payload format for generic forward error correction,” Internet Engineering Task Force Internet Draft draft-ietf-avt-ulp-23.txt, August 2007]. The payloads of the protected source packets using this proposal are split into consecutive byte ranges starting from beginning of the payload. The first byte range starting from the beginning of the packet corresponds to the strongest level of protection and the protection level decreases as a function of byte range order. Hence, the media data in the protected packets should be organized such a way that the data appears in descending order of importance with a payload and a similar number of bytes correspond to similar subjective impact in quality among the protected packets. The number of protected levels in FEC repair packets is selectable and an uneven level of protection can be obtained when number of levels protecting a set of source packets is varied. For example, if there are three levels of protection, one FEC packet may protect all three levels, a second one may protect the two first levels, and a third one only the first level. When applied to RTP payloads containing AMR-WB coded data, the ULP Internet Draft can be used to protect the more important class A bits more robustly compared to lower importance class B bits. Section 3.6 of IETF RFC 3267 and 3GPP TS 26.201 contain details of unequal error protection and bit classification of AMR and AMR-WB frames.

Furthermore whilst it is possible to design a FEC scheme which may offer different levels of protection according to the relative importance of different parameters in the stream, the approach does not offer the potential benefit of utilising a layered approach.

### SUMMARY OF THE INVENTION

This invention proceeds from the consideration that it is desirable to apply error control coding techniques to audio or speech codecs, which utilise the hybrid coding structure. Further in order to enhance the performance of these codecs over an IP packet based network, it is desirable to introduce a level of scalability into hybrid codecs such as the AMR family. This would enable error control coding to be applied partially to an encoded stream, where the overhead of error protection is such that it is not possible to protect the entire stream.

Embodiments of the present invention aim to address the above problem.

There is provided according to a first aspect of the present invention an encoder for encoding an audio signal, wherein the encoder comprises a first encoder configured to receive an first signal and generate a second signal dependent on the first signal; a second encoder configured to generate a third signal dependent on the second signal and the first signal; a signal processor configured to partition the third signal into at least two parts; and a multiplexer configured to receive at least one part of the third signal and the second signal and combine the said signals to output an encoded signal.

According to another aspect of the present invention, there is provided a method for encoding an audio signal, comprising receiving a first signal; generating a second signal dependent on the first signal; generating a third signal dependent on the second signal and the first signal; partitioning the third signal into at least two parts; and combining at least one part of the third signal and the second signal said signals to output an encoded signal.

According to a further aspect of the present invention, there is provided a decoder for decoding an encoded audio signal, wherein the decoder comprises a signal processor configured to receive an encoded signal and partition the encoded signal to generate at least a first part and a second part of the encoded signal, wherein the second part of the encoded signal comprises at least a first portion and a second portion; a combiner configured to receive at least the first portion of the second part of the encoded signal and generate a combined second part signal dependent at least on the first portion of the second part of the encoded signal.

According to a further aspect of the present invention, there is provided a method for decoding an encoded audio signal, comprising receiving an encoded signal; partitioning the encoded signal to generate at least a first part and a second part of the encoded signal, wherein the second part of the encoded signal comprises at least a first portion and a second portion; generating a combined second part signal dependent at least on the first portion of the second part of the encoded signal.

According to another aspect of the present invention, there is provided a computer program product configured to perform a method for encoding an audio signal, comprising receiving a first signal; generating a second signal dependent on the first signal; generating a third signal dependent on the second signal and the first signal; partitioning the third signal into at least two parts; and combining the at least two parts of the third signal and the second signal said signals to output an encoded signal.

According to another aspect of the present invention, there is provided a computer program product configured to perform a method for decoding an encoded audio signal, comprising receiving an encoded signal; partitioning the encoded signal to generate at least a first part and a second part of the encoded signal, wherein the second part of the encoded signal comprises at least a first portion and a second portion; generating a combined second part signal dependent at least on the first portion of the second part of the encoded signal.

According to another aspect of the present invention, there is provided an encoder for encoding an audio signal comprising coding means configured to receive an first signal and generate a second signal dependent on the first signal; further coding means configured to generate a third signal dependent on the second signal and the first signal; processing means configured to partition the third signal into at least two parts; and combining means configured to receive at least one part of the third signal and the second signal and combine the said signals to output an encoded signal.

According to another aspect of the present invention, there is provided a decoder for decoding an audio signal, comprising processing means configured to receive an encoded signal and partition the encoded signal to generate at least a first part and a second part of the encoded signal, wherein the second part of the encoded signal comprises at least a first portion and a second portion; combiner means configured to receive at least the first portion of the second part of the encoded signal and generate a combined second part signal dependent at least on the first portion of the second part of the encoded signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2a shows schematically an audio encoder employing an embodiment of the present invention;

FIG. 2b shows schematically a part of the audio encoder shown in FIG. 2a;

FIG. 3 shows a flow diagram illustrating the operation of the audio encoder according to an embodiment of the present invention;

FIG. 4a shows schematically an audio decoder according to an embodiment of the present invention; FIG. 4b shows schematically a part of the audio decoder shown in FIG. 4a;

FIG. 5a shows a flow diagram illustrating the operation of an embodiment of the audio decoder according to the present invention;

FIG. 5b shows a flow diagram illustrating part of the operation shown in FIG. 5a; and

FIG. 6 shows a schematic view of the mapping of the parametric and residual coders according to the present invention.

### DESCRIPTION OF EXEMPLARY EMBODIMENTS OF THE INVENTION

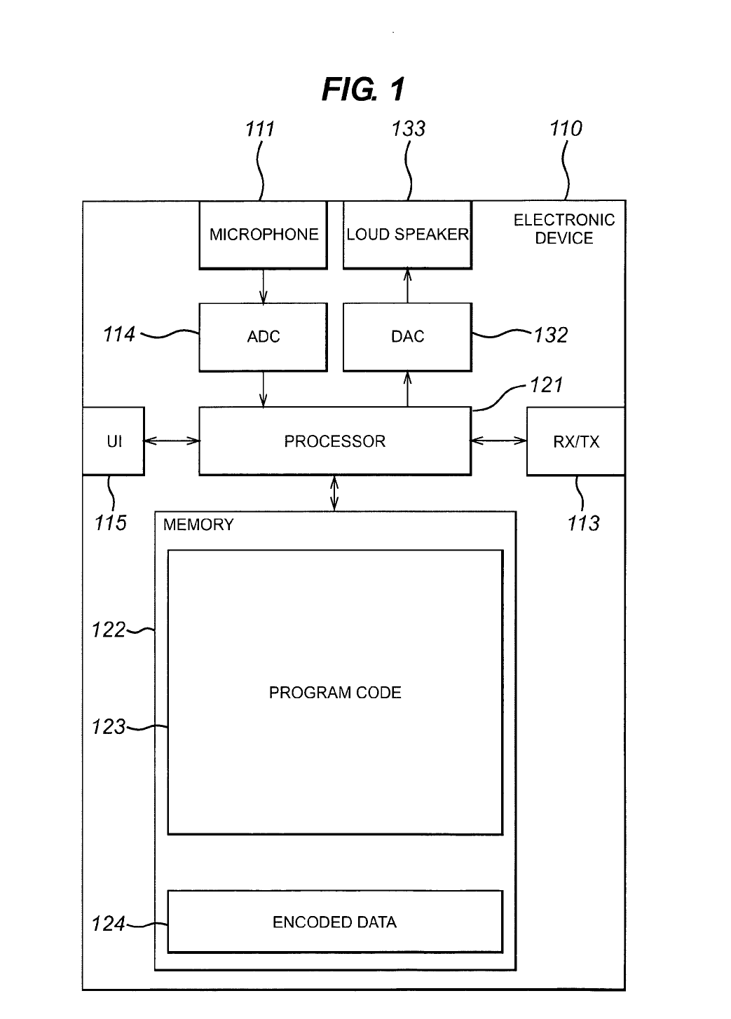

The following describes in more detail possible codec mechanisms for the provision of layered or scalable variable rate audio codecs. In this regard reference is first made to FIG. 1 schematic block diagram of an exemplary electronic device 110, which may incorporate a codec according to an embodiment of the invention.

The electronic device 110 may for example be a mobile terminal or user equipment of a wireless communication system.

The electronic device 110 comprises a microphone 111, which is linked via an analogue-to-digital converter 114 to a processor 121. The processor 121 is further linked via a digital-to-analogue converter 132 to loudspeaker(s) 133. The processor 121 is further linked to a transceiver (TX/RX) 113, to a user interface (UI) 115 and to a memory 122.

The processor 121 may be configured to execute various program codes. The implemented program codes comprise an audio encoding code or a speech encoding code which may be used to encode the incoming audio type signal. The implemented program codes 123 may further comprise an audio decoding code or speech decoding code. The implemented program codes 123 may be stored for example in the memory 122 for retrieval by the processor 121 whenever needed. The memory 122 could further provide a section 124 for storing data, for example data that has been encoded in accordance with the invention.

The encoding and decoding code may in embodiments of the invention be implemented in electronic based hardware or firmware.

The user interface 115 enables a user to input commands to the electronic device 110, for example via a keypad, and/or to obtain information from the electronic device 110, for example via a display. The transceiver 113 enables a communication with other electronic devices, for example via a wireless communication network.

It is to be understood again that the structure of the electronic device 110 could be supplemented and varied in many ways.

A user of the electronic device 110 may use the microphone 111 for inputting speech that is to be transmitted to some other electronic device or that is to be stored in the data section 124 of the memory 122. A corresponding application has been activated to this end by the user via the user interface 115. This application, which may be run by the processor 121, causes the processor 121 to execute the encoding code stored in the memory 122,

The analogue-to-digital converter 114 converts the input analogue audio signal into a digital audio signal and provides the digital audio signal to the processor 121.

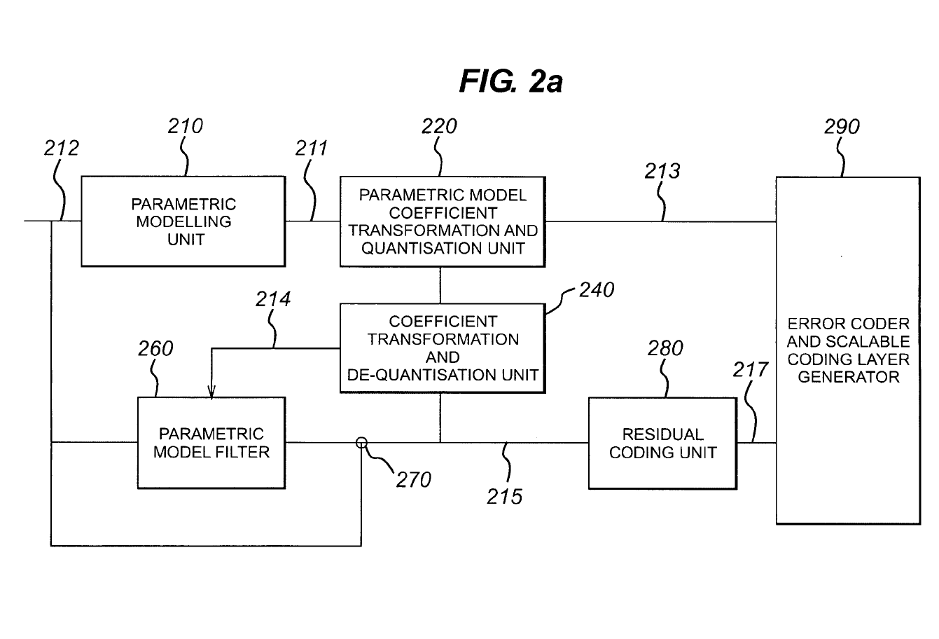

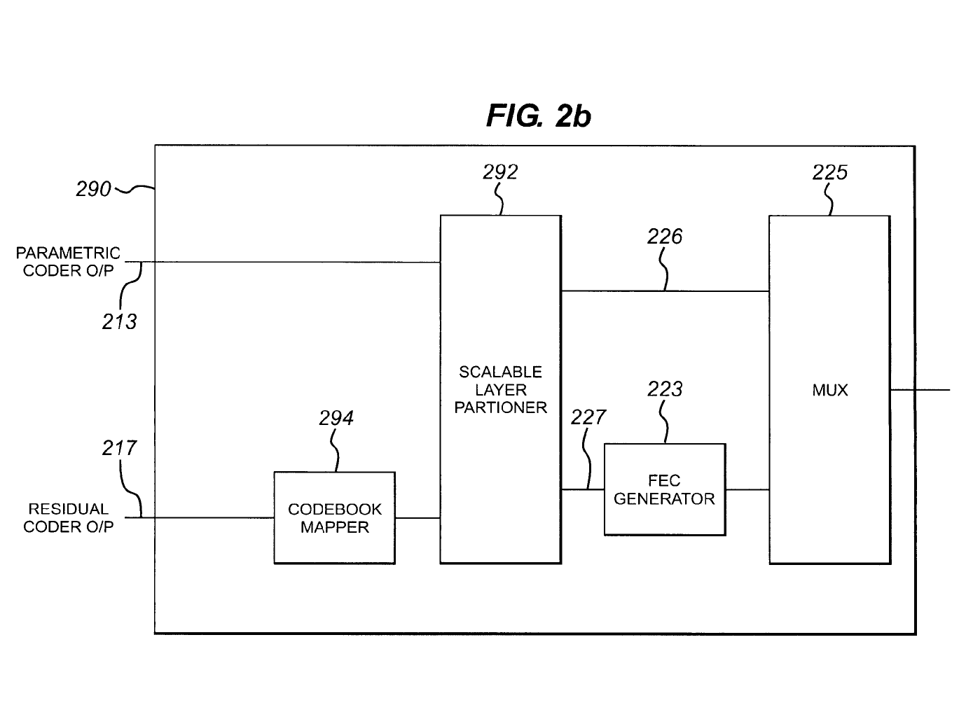

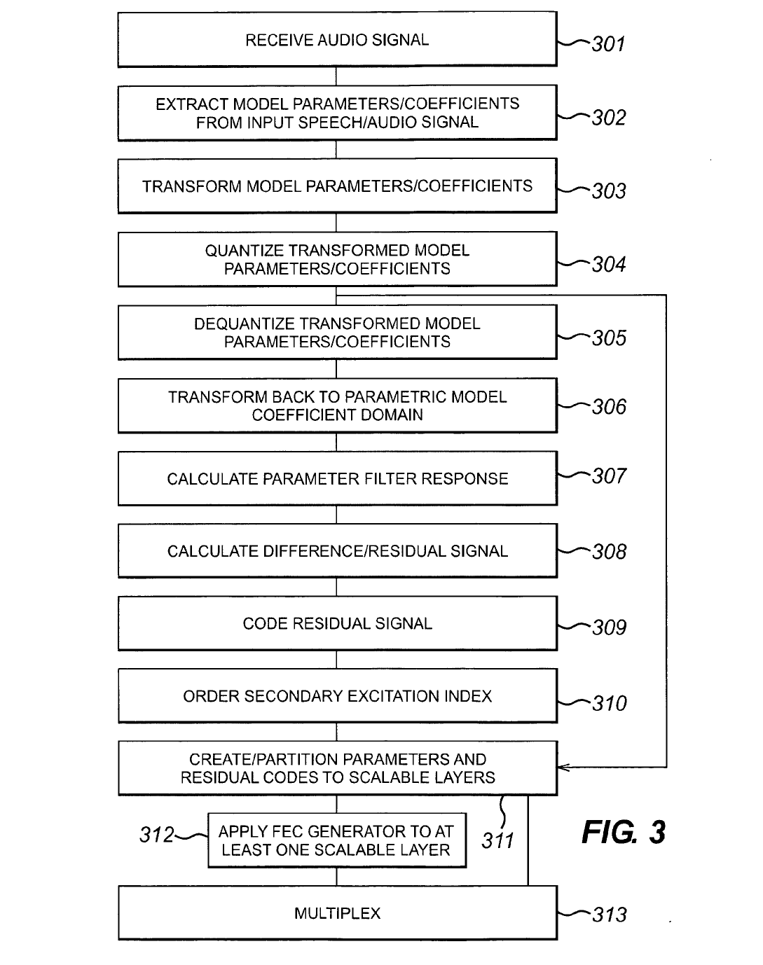

The processor 121 may then process the digital audio signal in the same way as described with reference to FIGS. 2 and 3.

The resulting bit stream is provided to the transceiver 113 for transmission to another electronic device. Alternatively, the coded data could be stored in the data section 124 of the memory 122, for instance for a later transmission or for a later presentation by the same electronic device 110.

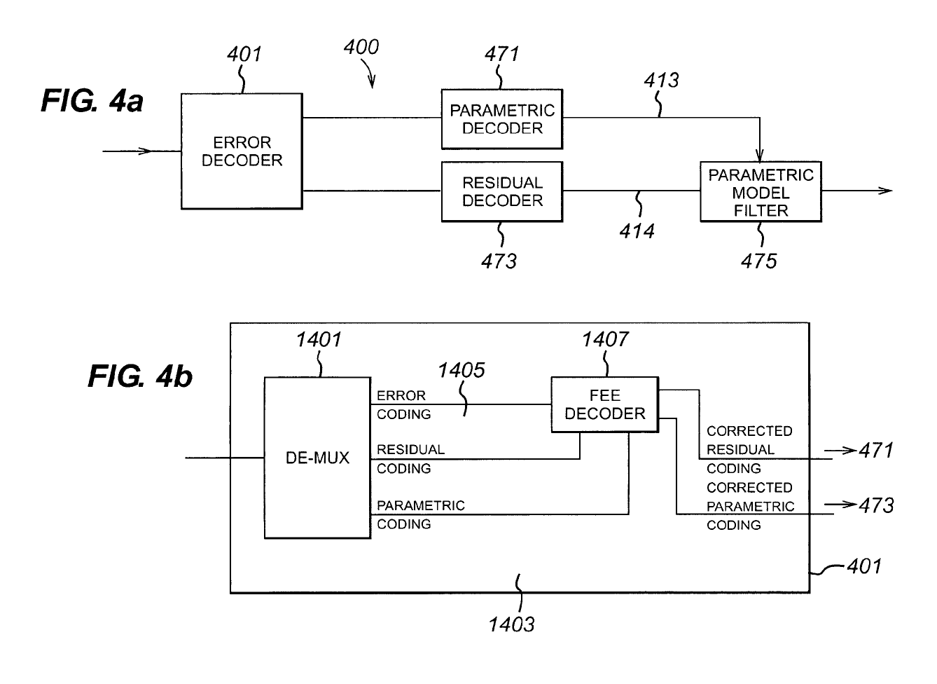

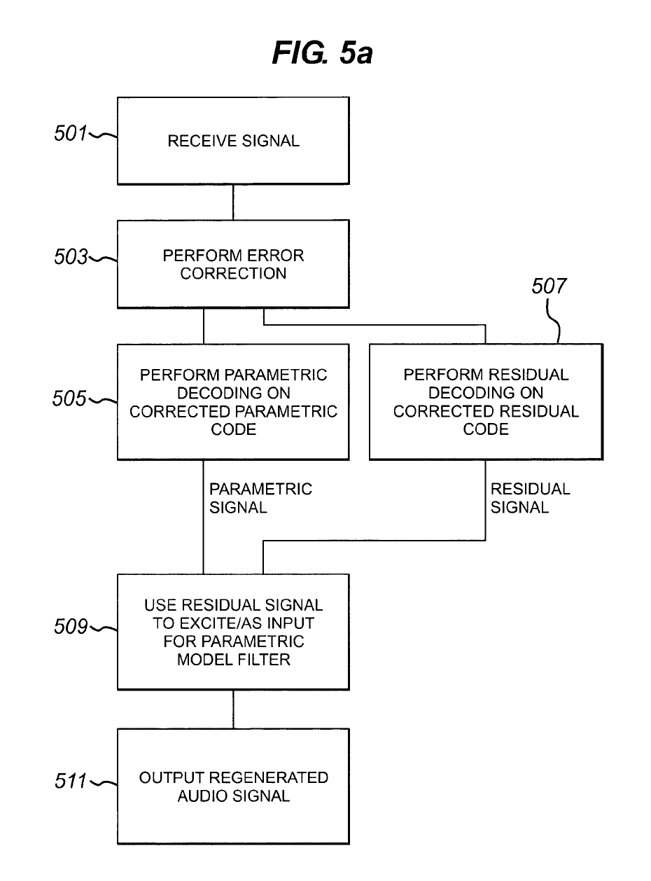

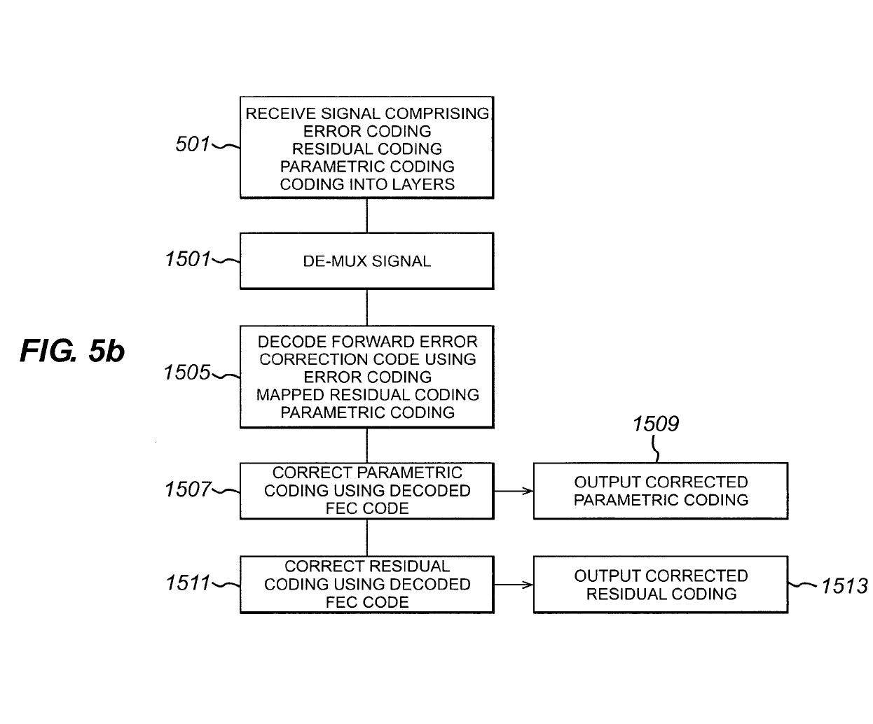

The electronic device 110 could also receive a bit stream with correspondingly encoded data from another electronic device via its transceiver 113. In this case, the processor 121 may execute the decoding program code stored in the memory 122. The processor 121 decodes the received data, for instance in the same way as described with reference to FIGS. 4 and 5, and provides the decoded data to the digital-to-analogue converter 132. The digital-to-analogue converter 132 converts the digital decoded data into analogue audio data and outputs them via the loudspeaker(s) 133. Execution of the decoding program code could be triggered as well by an application that has been called by the user via the user interface 115.

The received encoded data could also be stored instead of an immediate presentation via the loudspeakers 133 in the data section 124 of the memory 122, for instance for enabling a later presentation or a forwarding to still another electronic device.

It would be appreciated that the schematic structures described in FIGS. 2 and 4 and the method steps in FIGS. 3 and 5 represent only a part of the operation of a complete audio codec as exemplarily shown implemented in the electronic device shown in FIG. 1. The general operation of audio codecs is known from the art and features of such codecs which do not assist in the understanding of the operation of the invention are not described in detail.

The embodiment of the invention audio codec is now described in more detail with respect to FIGS. 2 to 5.

With respect to FIGS. 2a, 2b, 3 a view of an encoder (otherwise known as the coder) embodiment of the invention is shown.

Typically speech and audio codecs which are based on the Code Excited Linear Prediction (CELP) architecture, such as the AMR family of codecs, may typically segment a speech signal into frames of 20 ms duration, and then may further segment the frame into a plurality of subframes. Parametric modelling of the signal may then be performed over the frame, and these typically may be represented in the form of Linear Predictive Coding (LPC) coefficients. In order to facilitate quantisation, storage and transmission of these parameters they may be transformed to a further form, typically Line Spectral Frequencies (LSF) or ISP (Immittance Spectral Pair). Also, at the subframe level the audio or speech signal may be further modelled by using tools such as long term prediction (LTP) and secondary excitation generation or fixed codebook excitation. Typically the secondary or fixed codebook excitation step models the residual signal, i.e. the signal which may be left once the contributions from the parametric modelling and long term prediction tools have been removed. According to an exemplary embodiment of the present invention parametric modelling followed by the long term prediction and secondary excitation stages may be constituted as a core or base layer codec. Further embodiments of the present invention may constitute a core or base level codec as consisting of parametric modelling stage followed by a secondary excitation step.

According to an exemplary embodiment of the present invention scalable or embedded coding layers may be formed when the residual signal is coded using a secondary excitation step. In one embodiment of the present invention, which employs an algebraic secondary fixed codebook excitation, the excitation vector may be sparsely populated with individual pulses. Such a form of secondary excitation vector may be found in the AMR family of codecs. It may be possible that an optimum excitation vector may contain a number of individual pulses distributed within a vector whose dimension is not limited to but may be a factor of the sub-frame length. According to embodiments of the present invention the optimum excitation vector may be selected from a codebook of excitation vectors based for example on a minimum mean square error or some other error criteria between the residual signal and the filtered excitation vector. The optimum excitation vector may then be divided into a number of sets of pulses, whereby the members of each set is made up of a number of individual pulses. Each of one of the sets of pulses is then coded whereby the binary index pattern of the code may represent the position or relative position and also the sign of each pulse within the set. The binary code representing each set of pulses may then be concatenated together to form a binary coded representing the overall optimum excitation vector.

In an exemplary embodiment of the present invention the order of concatenation may be done in a hierarchical manner, whereby the sets of pulses are arranged in decreasing order of subjective importance. Equally in further embodiments of the present invention the binary coded sets of pulses may be arranged in an increasing order of subjective importance.

A Scalable/embedded layered structure may then be formed, by ensuring that at least one of the coded set of pulses is arranged to be a core or base layer.

Typically this core layer coded set may be arranged, to be at the start of the overall concatenated binary coded sequence. Alternatively the core layer coded set may be arranged to map to the end of the overall concatenated binary sequence. Subsequent coded sets may then form the additional scalable/embedded layers.

The binary bit groups representing the coded sets may then be arranged relative to the coded base layer in order of their assigned layer, within the overall binary coded optimum excitation vector.

According to this aspect of the invention, a scalable/embedded layered coding architecture is introduced by segmenting the secondary optimally chosen excitation vector into groups of pulses. The said groups of pulses may then be arranged as binary coded groups as a concatenated binary vector where the relative order of coded groups is determined by the order of the scalable layers. In this aspect of the invention the core (or base) layer may further comprise parametric model parameters and other previous signal modelling or waveform matching steps such as those parameters associated with long term prediction tools and any additional previous secondary fixed (codebook) excitation stages.

Further embodiments of the present invention may comprise a core (or base) layer consisting solely of parametric model parameters, and parameters associated with LTP and any previous secondary excitation stages.

According to a further exemplary embodiment of the present invention forward error correction (FEC) may be applied on the basis that a fixed number of FEC bits are used to protect the coded parameter set. Further, the number of source bits used to code the parameter set may vary according to the operating mode, or the number of coding layers used at the encoder. Now, the FEC bits may be arranged such that they protect the core (or base) layer. However in cases where the number of bits allocated to FEC correction is greater than what is required to protect the core layer then those remaining bits may allocated to protecting some of the higher coding layers.

FIG. 2a depicts a schematic diagram illustrating an exemplary embodiment of the present invention for the encoder 200. Furthermore, the operation of the exemplary embodiment is described by means of the flow diagram depicted in FIG. 3.

The encoder 200 may be divided into: a parameter modelling unit 210; a parametric model filter 260; residual coding unit 280; core (base) layer and Parametric model coefficient transformation and quantization unit 220; parametric model de-quantisation unit 240; a difference unit 270, and an error coder 290.

The encoder 200 in step 301 receives the original audio signal. In a first embodiment of the invention the audio signal is a digitally sampled signal. In other embodiments of the present invention the audio input may be an analogue audio signal, for example from a microphone 111, which is analogue to digitally (A/D) converted. In further embodiments of the invention the audio input is converted from a pulse code modulation digital signal to amplitude modulation digital signal.

The parametric modelling unit 210 may receive the audio/speech signal 212 and then may analyse this signal in order to extract the parameters of the model, this is depicted in step 302 in FIG. 3. This signal may typically be modelled in terms of the short term correlations in the signal, using techniques such as, but not limited to, Linear Predictive Coding (LPC) analysis.

The output of such a process is the parameters of the model, which for example in this exemplary embodiment may be LPC coefficients. However the model parameters (or coefficients) may equally be encapsulated in other forms such as reflection coefficients. These model coefficients are then passed along connection, 211, to the coefficient transformation and quantisation unit 220.

Within the coefficient transformation and quantisation unit 220, as depicted by step 303 in FIG. 3, the coefficients of the parametric model may then be transformed into an alternative form, which may be more conducive to transmission across a communications link or storage on an electronic device.

For example the LPC parameters may be transformed into Line Spectral Pairs (LSP) or Immittance Spectral Pairs (ISP), and reflection coefficients may be transformed into Log Area Ratios (LAR). These transformed model coefficients may then be quantised, as depicted by step 304 in FIG. 3. Non limiting examples of quantisation processes include; vector, scalar or lattice quantisation schemes. Further these quantised coefficients may form the output parameters of the parametric coding stage of the hybrid coder. These are depicted in FIG. 2a as being passed along connection 213 to the error coder and scalable coding layer generator 290.

The coefficient transformation and de-quantisation unit 240 may then pass the (quantised) output parameters through a de-quantisation process where they are transformed back to the parameter coefficient domain. This is shown in steps 305 and 306 from FIG. 3. In step 305 the coefficient transformation and de-quantisation unit 240 may de-quantise the transformed model parameters/coefficients. In step 306 the coefficient transformation and de-quantisation unit 240 may transform the transformed model parameters/coefficients into the model coefficient domain. The de-quantised parametric model coefficients may then be passed along connection 214 where they may be used as part of the parametric model filter 260.

The parametric model filter 260 may remove the effects of the model from the incoming speech/audio signal along connection 212, which in turn may result in the short term correlations in the signal being removed. This may take the form of generating the memory response of the synthesis LPC filter and then removing this signal from the speech/audio signal by means of the difference unit, 270.

However, further embodiments may achieve this by passing the speech/audio signal through an inverse LPC filter.

The process of removing the effect of the parametric model from the incoming speech signal is depicted in FIG. 3 by steps 307, where the parametric model filter 260 may form the parameter filter response, and 308, where the difference unit 270 may calculate the difference/residual signal.

The output of step 308, the residual signal, may then be passed along connection 215 to the residual coding unit 280.

The residual coding unit 280 may further model the residual signal, as depicted in FIG. 3 step 309. The residual coding unit may perform the step of modelling the long term correlations in the residual signal. This may take the form of a Long Term Predictor (LTP), whose parameters may be represented as a pitch lag and gain. It is to be understood that the parameters of the LIP may comprise of at least one lag value, and of at least one gain value. The effect of the LTP operation may then be removed from the residual signal by a difference unit, to leave a further residual signal. This further residual signal may then be additionally modelled by a fixed secondary excitation or codebook excitation operation.

This step may represent any residual information that remains in the speech/audio signal. For instance it may model signal characteristics which have failed to have been modelled by previous coding stages. This operation may comprise selecting at least one excitation vector from a fixed codebook and determining at least one gain associated with the at least one excitation vector. Typically the gain factors associated with these stages are quantised using techniques such as, but not limited to, scalar, vector and lattice quantisation. These quantised gains together with any LTP lag, and codebook indices may typically constitute the residual coder parameter set or signal.

The outputs from the parametric and residual coders are passed, on connections 213 and 217 respectively, to the codec embedded layer generator and FEC coder, 290.

In FIG. 2b the codec embedded layer generator and FEC coder (Error coder and scalable coding layer generator), 290, as embodied by the invention is shown in further detail. The codec embedded layer generator and FEC coder 290 comprises a secondary codebook excitation vector index mapping operation, depicted as a codebook mapper, 294 in FIG. 2b.

The codebook mapper may comprise an ordering operation which arranges the bit pattern of the secondary codebook excitation vector index into a number of concatenated sub-groups. This ordering operation is depicted by the step 310 in FIG. 3. Each sub-group may represent a sub-set of the total vector components present in the excitation vector.

The scalable layer partitioner 292 may then combine the output from the codebook mapper 294 with any residual coded parameters which have not been ordered by the codebook mapper 294 together with the parametric coded parameters from the parametric coder output on connection 213.

Furthermore the scalable layer partitioner 292 may distribute or partition the parameters into scalable embedded layers. The scalable embedded layers may comprise a core (base) layer and higher layers. This distribution of parameters is shown in FIG. 3 by step 311.

A non limiting partitioning step may for example comprise a base layer, made up from the parametric model coefficients from the parametric coder, and LTP parameters with binary indices and gains representing a sub-group of vector components of the chosen secondary excitation vector from the output of the codebook mapper 294. The remaining secondary excitation vector sub-groups may then form the higher coding layers.

However it is to be understood that the coded parameters used for the base (core) and higher layers may comprise any combination of codec parameters. For example, further embodiments of the invention may have configurations, which comprise a core (base) layer consisting of parametric model coefficients and LTP parameters. The higher layers may then be drawn from the concatenated binary indices representing the groups of vector components present in the secondary excitation vector, i.e. the output of the codebook mapper stage 294.

Thus each higher layer drawn from the secondary codebook excitation vector may comprise of a mutually exclusive set of secondary excitation vector components. Furthermore, each higher layer may encode the secondary excitation vector at a progressively higher bit rate and quality level. The output of the scalable layer partitioner 292 may be distributed to an encoded stream, where the distribution may be in the order of the coding layers.

An output of the scalable layer partitioner 292 may then pass along connection 227 to the FEC generator 223. The FEC generator may, as depicted by step 312 in FIG. 3, apply a FEC generator matrix to one or more of the embedded scalable layers. The application of the FEC generator matrix may provide forward error protection to these layers, Non limiting examples of forward error correcting schemes which may be used include: Linear Block coding schemes such as Hamming codes, Hadamard codes and Golay codes, Convolutional coding, including recursive convolutional coding, Reed Solomon Coding, and Cyclic codes.

In further embodiments of the present invention a forward error detector generator might be applied instead or in addition to the FEC scheme. Typical examples of a forward error detector generator scheme is Cyclic Redundancy Check (CRC) coding.

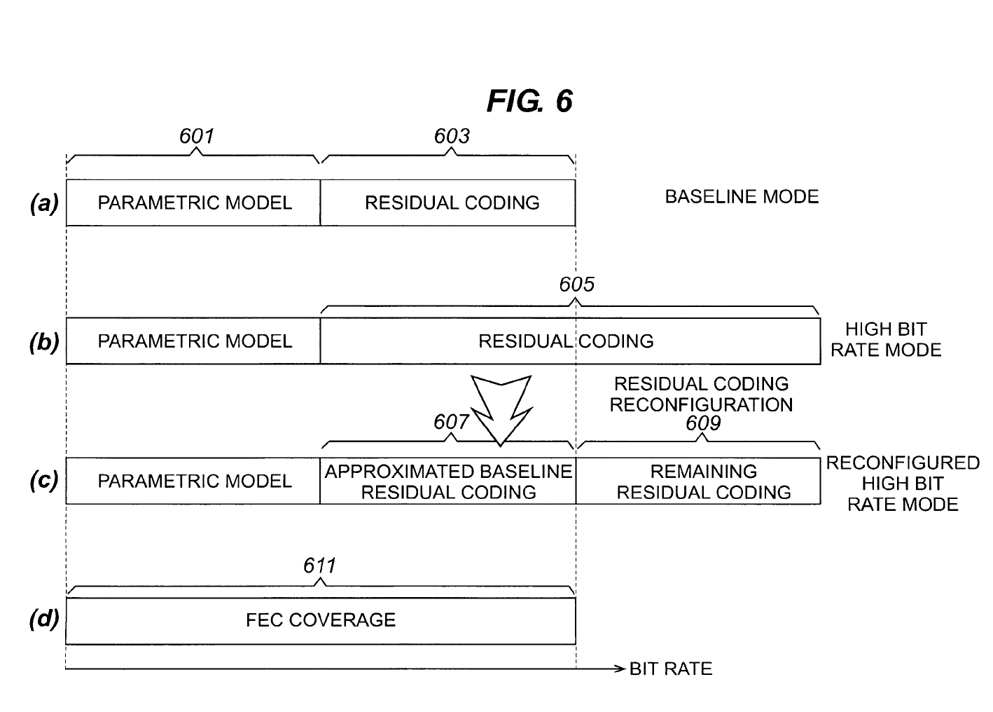

The process of mapping the output of the parametric and residual coders to scalable embedded layers according to the present invention is exemplarily depicted in FIG. 6. This exemplary embodiment is applied to the case of a multi-rate codec, whose output rate may be switched to one of a set of possible rates during its mode of operation, non limiting examples include, AMR and AMR-WB. FIG. 6(a) depicts the case of the aforementioned codec operating in a so called baseline mode. This may be a coding rate which has been selected as a base operating rate for the codec, a non limiting example for AMR-WB may its operating rate of 12.65 kbps. It should be noted that in this exemplary embodiment the FEC coverage, as depicted in FIG. 6(d), has been arranged to protect the Parametric model parameters and residual coding components.

FIG. 6(b) depicts the case where the coding mode has been switched to a higher bit rate. A non limiting example for AMR-WB might be 23.05 kbps. It is to be understood that the codec is depicted as operating in its normal mode of operation, i.e. the encoded stream has not been partitioned into scalable coding layers. It can be seen that the residual coding bit rate has been extended to accommodate the higher bit rate of the secondary excitation. Furthermore, it should be noted that the bit rate of the residual code is larger than the scope of FEC coverage, and therefore no longer benefits from full coverage.

FIG. 6(c) depicts the case where the residual coding component has been arranged into coding layers according to an exemplary embodiment of the present invention. It can be now seen that FEC provides coverage for the codecs base (or core layer), thereby ensuring a minimum level of quality is achieved.

It is to be understood that in further embodiments of the present invention that all embedded scalable layers may be applied to the FEC generator, thereby receiving full FEC coverage.

If ACELP is used, the encoder output bit stream may include typical ACELP encoder parameters. Non-limiting examples of these parameters include LPC (Linear prediction calculation) parameters quantized in LSP (Line Spectral Pair) or ISP (Immittance Spectral Pair) domain describing the spectral content, LTP (long-term prediction) parameters describing the periodic structure, ACELP excitation parameters describing the residual signal after linear predictors, and signal gain parameters.

Although the above embodiments have been described as producing a base (or core) layer, it is to be understood that further embodiments may adopt differing number of core encoding layers, thereby being capable of achieving different levels of granularity in terms of both bit rate and audio quality.

In the embodiment described hereafter the present invention is exemplarily described with respect to the AMR-WB codec, but it is to be understood that the present invention and the exemplary method of partitioning a residual coding stage into multiple coding layers can also be applied to any other suited speech or audio codec, such as those codec families adopting the Code Excited Linear Prediction (CELP) codec architecture or other time domain frame based codecs.

The (fixed codebook) residual coding of an AMR-WB codec is based on discrete pulses. The 256-sample frame is divided into four subframes of 64 samples. Each subframe of 64 samples is further divided into four interleaved tracks, each containing 16 possible pulse positions. Different bit rate codec modes are constructed by placing different number of pulses on these tracks. The baseline mode of operation for this embodiment of the invention, the 12.65 kbps mode, has two non-zero pulses on each track, resulting in total of eight non-zero pulses in a subframe.

The pulse coding algorithms for different number of pulses are described below. The pulse position quantisation is described in detail in the document 3GPP TS 26.190 AMR-WB; Transcoding functions. The mapping to bit field and corresponding two-pulse configuration selection is described in separate subsections.

In this codebook, the innovation vector contains 8 non-zero pulses. All pulses can have the amplitudes +1 or -1. The 64 positions in a subframe are divided into 4 tracks, where each track contains two pulses, as shown in Table 1.

TABLE 1
Potential positions of individual pulses in the algebraic codebook, 12.65
kbps [TS 26.190]

| Track | Pulse | Positions |
|---|---|---|
| 1 | i₀, i₄ | 0, 4, 8, 12, 16, 20, 24, 28, 32, 36, 40, 44, 48, 52, 56, 60 |
| 2 | i₁, i₅ | 1, 5, 9, 13, 17, 21, 25, 29, 33, 37, 41, 45, 49, 53, 57, 61 |
| 3 | i₂, i₆ | 2, 6, 10, 14, 18, 22, 26, 30, 34, 38, 42, 46, 50, 54, 58, 62 |
| 4 | i₃, i₇ | 3, 7, 11, 15, 19, 23, 27, 31, 35, 39, 43, 47, 51, 55, 59, 63 |

Each two pulse positions in one track are encoded with 8 bits (total of 32 bits, 4 bits for the position of every pulse), and the sign of the first pulse in the track is encoded with 1 bit (total of 4 bits). This gives a total of 36 bits for the algebraic code.

In case of two pulses per track of K=2^{M} potential positions (here M=4), each pulse needs 1 bit for the sign and M bits for the position, which gives a total of 2M+2 bits. However, some redundancy exists due to the unimportance of the pulse ordering. For example, placing the first pulse at position p and the second pulse at position q is equivalent to placing the first pulse at position q and the second pulse at position p. One bit can be saved by encoding only one sign and deducing the second sign from the ordering of the positions in the index. Here the index is given by

I₂ₚ=p₁+p₀×2^{M}+s×2^{2M}

where s is the sign index of the pulse at position index p₀. If the two signs are equal then the smaller position is set to p₀ and the larger position is set to p₁. On the other hand, of the two signs are not equal then the larger position is set to p₀ and the smaller position is set to p₁. At the decoder, the sign of the pulse at position p₀ is readily available. The second sign is deduced from the pulse ordering. If p₀ is larger than p₁ then the sign of the pulse at position p₁ is opposite to that at position p₀. If this is not the case then the two signs are set equal

The bit field for two pulses for the each track for 12.65 kbps mode is presented in Table 2. Both first and second pulse positions are encoded with four bits and the combined sign information with one bit.

TABLE 2
Bit field for 2 pulses/track in 12.65 kbps mode

| 0 | 1 | 2 | 3 | 4 | 5 | 6 | 7 | 8 |
|---|---|---|---|---|---|---|---|---|
| p₁ | p₁ | p₁ | p₁ | p₀ | p₀ | p₀ | p₀ | s |

The baseline residual coding bit stream for FEC protection is thus considered as 9 bits/track resulting in 36 bits/frame.

In part (b) it can be seen that selecting more than two pulses per track the bit rate is significantly increased. Thus in (b) the parametric coding code 601 has the same bit rate but residual high bit rate 605 mode has a much greater bit rate.

However the FEC coverage for the available signal whilst covering the baseline mode for both the parametric and residual coding in baseline mode is not able to cover all of the residual coding in the high bit rate mode.

The codebook mapper 294 thus partitions the high bit rate mode into an approximated baseline residual coding portion 607—which is capable of being protected by the forward error correction codes, and a remaining residual coding portion 609 which is not protected by the FEC codes.

The operation of the codebook mapper 294 is further described in detail below. As the detailed description of pulse coding reconfiguration below shows, first two pulses are not always suitable for the approximated baseline since they may consume too many bits. The reconfiguration has two conditions: 1) The bit rate is to be equal to or less than the bit rate of the baseline coding. 2) The resulting bit field needs to be configurable to a baseline compatible format.

Firstly the codebook mapper 294 determines what is the mode of the residual code. Once the mode is determined the approximation to the baseline mode is performed.

Examples of the approximation operation of the codebook mapper 294 in embodiments of the invention are now described.

If three pulses per track are determined, a process similar to the two pulse or baseline mode may be employed. For a track with 2^{M} positions, 3M+1 bits are used instead of 3M+3 bits. The codebook mapper indexes the pulses by dividing the track positions in two sections (or halves) and identifying a section that contains at least two pulses. The number of positions in each section is K/2=2^{M}/2=2^{M-1}, and can be represented with M−1 bits. The two pulses in the section containing at least two pulses are encoded with the procedure for encoding 2 signed pulses which requires 2(M−1)+1 bits as is described above and the remaining pulse which can be anywhere in the track (in either section) is encoded with M+1 bits. Finally, the index of the section that contains the two pulses is encoded with 1 bit. Thus the total number of required bits is 2(M−1)+1+M+1+1=3M+1. One way of determining if two pulses are positioned in the same section is by determining whether the most significant bits (MSB) of the position indices of the pulses are equal or not. A MSB of 0 indicates that the position belongs to the lower half of the track (0-7) and MSB of 1 indicates that the position belongs to the upper half (8-15). If the two pulses belong to the upper half, the pulses can be shifted to the range (0-7) before encoding the pulses using 2×3+1 bits. This can be done by masking the M−1 least significant bits (LSB) with a mask consisting of M−1 ones (which corresponds to the number 7 in this case).

The index of the 3 signed pulses is given by

I₃ₚ=I₂ₚ+k×2^{2M-1}+I₁ₚ×2^{2M}

where I₂ₚ is the index of the two pulses in the same section, k is the section index (0 or 1), and I₁ₚ is the index of the third pulse in the track.

The example bit field for three pulses for the each track is presented in Table 3.

TABLE 3
Bit field for 3 pulses/track combination

| 0 | 1 | 2 | 3 | 4 | 5 | 6 | 7 | 8 | 9 | 10 | 11 | 12 |
|---|---|---|---|---|---|---|---|---|---|---|---|---|
| p₁ | p₁ | p₁ | p₀ | p₀ | p₀ | s₀ | k | p₂ | p₂ | p₂ | p₂ | s₁ |

The pulse coding is different when compared to the 2 pulses/track coding. However, the first two pulses may be extracted from the bit stream. The bit allocation is arranged in such a way that the first 9 bits contain the information of the position and sign of the two first pulses (in this example only the first 8 bits are used to reconstruct a two pulse residual coding).

In principle, the codebook mapper 294 may (or encoder, or some media gateway on the transmission path) discard the remaining bits leaving only the first 9 bits but would still contain information to approximate a 2 pulse/track coding. Thus in some embodiments of the invention the receiver/decoder may decode the received stream without knowing the coding mode to be able to map the reduced bit stream into a two pulse configuration of the 12.65 coding mode.

For example the positions of two first pulses in Table 3 can be mapped in the codebook mapper 294 to form an approximation as shown according to Table 4.

TABLE 4
2 pulses/track mapped for approximating 12.65 kbps decoding

| 0 | 1 | 2 | 3 | 4 | 5 | 6 | 7 | 8 |
|---|---|---|---|---|---|---|---|---|
| k | p₁ | p₁ | p₁ | k | p₀ | p₀ | p₀ | s₀ |

The section information k is placed as the most significant bit for first and second pulse position bit field. K=0 maps the pulse to first section, and k=1 moves the pulse to the second section. Sign information is similar to the original 12.65 mode coding.

The reconstructed two pulse coding in this example is an approximation of the native two pulse coding of 12.65 mode. As both pulses are on the same section they do not span the full track, but are in the range 0 . . . 31 or 32 . . . 64.

If 4 signed pulses per track are determined, the 4 pulses in a track of length K=2^{M} can be encoded using 4M bits. In an operation similar to the case of 3 pulses, the K positions in the track are divided into 2 sections (two halves) where each section contains K/2=8 positions. The sections are denoted as Section A with positions 0 to K/2−1 and Section B with positions K/2 to K−1. Each section can contain from 0 to 4 pulses. The table below shows the 5 cases representing the possible number of pulses in each section:

TABLE 5
Possible pulse combinations in subframe sections

| case | Pulses in Section A | Pulses in Section B | Bits needed |
|---|---|---|---|
| 0 | 0 | 4 | 4M-3 |
| 1 | 1 | 3 | 4M-2 |
| 2 | 2 | 2 | 4M-2 |
| 3 | 3 | 1 | 4M-2 |
| 4 | 4 | 0 | 4M-3 |

In cases 0 or 4, the 4 pulses in a section of length K/2=2^{M-1} can be encoded using 4(M−1)+1=4M−3 bits.

In cases 1 or 3, the 1 pulse in a section of length K/2=2^{M-1} can be encoded with M−1+1=M bits and the 3 pulses in the other section can be encoded with 3(M−1)+1=3M−2 bits. This gives a total of M+3M−2=4M−2 bits.

In case 2, the pulses in a section of length K/2=2^{M-1} can be encoded with 2(M−1)+1=2M−1 bits. Thus for both sections, 2(2M−1)=4M−2 bits are used.

Furthermore the case index can be encoded with 2 bits as there are 4 possible cases (assuming cases 0 and 4 are combined). Thus for cases 1, 2, or 3, the number of bits used is 4M−2 to encode the index plus 2 further bits to encode the case index which produces a total of 4M−2+2=4M bits. For cases 0 or 4, one bit is used for identifying whether it is a case 0 or case 4 situation, 4M−3 bits are used for encoding the 4 pulses in the section, and 2 bits are used to define the case index, which also gives a total of 1+4M−3+2=4M bits.

The index of the 4 signed pulses is given by

I₄ₚ=I_{AB}+k×2^{4M-2}

where k is the case index (2 bits), and I_{AB} is the index of the pulses in both sections for each individual case.

For cases 0 and 1, I_{AB} is given by

I_{AB}_{_{—}}_{0,4}=I₄ₚ_{_{—section}}+j×2^{4M-3}

where j is a 1-bit index identifying the section with 4 pulses and I₄ₚ_{_{—}}_{section} is the index of the 4 pulses in that section (which requires 4M−3 bits).

For case 1, I_{AB} is given by

I_{AB}_{_{—}}₁=I₃ₚ_{_{—}}_{B}+I₁ₚ_{_{—}}_{A}×2^{3(M-1)+1}

where I₃ₚ_{_{—}}_{B} is the index of the 3 pulses in Section B (3(M−1)+1 bits) and I₁ₚ_{_{—}}_{A} is the index of the pulse in Section A ((M−1)+1 bits).

For case 2, I_{AB} is given by

I_{AB}_{_{—}}₂=I₂ₚ_{_{—}}_{B}+I₂ₚ_{_{—}}_{A}×2^{2(M-1)+1}

where I₂ₚ_{_{—}}_{B} is the index of the 2 pulses in Section B (2(M−1)+1 bits) and I₂ₚ_{_{—}}_{A} is the index of the two pulses in Section A (2(M−1)+1 bits).

Finally, for case 3, I_{AB} is given by

I_{AB}_{_{—}}₃=I₁ₚ_{_{—}}_{B}+I₃ₚ_{_{—}}_{A}×2^{M}

where I₁ₚ_{_{—}}_{B} is the index of the pulse in Section B ((M−1)+1 bits) and I₃ₚ_{_{—}}_{A} is the index of the 3 pulses in Section A (3(M−1)+1 bits).

For cases 0 and 4, the 4 pulses in one section are encoded using 4(M−1)+1 bits. This is done by further dividing the section into 2 subsections of length K/4=2^{M-2} (=4 in this case); identifying a subsection that contains at least 2 pulses; coding the 2 pulses in that subsection using 2(M−2)+1=2M−3 bits; coding the index of the subsection that contains at least 2 pulses using 1 bit; and coding the remaining 2 pulses, assuming that the pulses can be anywhere in the section, using 2(M−1)+1=2M−1 bits. This gives a total of (2M−3)+(1)+(2M−1)=4M−3 bits.

The bit field for four pulses for the each track is presented below in Table 6.

TABLE 6
Bit field options for 4 pulses/track combination

| Case | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| 0, 4 | s₀ | p₀ | p₀ | p₁ | p₁ | s_{b} | s₁ | p₂ | p₂ | p₂ | p₃ | p₃ | p₃ | c | c | s_{c} |
| 1 | s₀ | p₀ | p₀ | p₁ | p₁ | s_{b} | s₁ | p₂ | p₂ | p₂ | s₂ | p₃ | p₃ | p₃ | c | c |
| 2 | s₀ | p₀ | p₀ | p₀ | p₁ | p₁ | p₁ | s₁ | p₂ | p₂ | p₂ | p₃ | p₃ | p₃ | c | c |
| 3 | s₀ | p₀ | p₀ | p₀ | s₁ | p₁ | p₁ | p₂ | p₂ | s_{b} | s₂ | p₃ | p₃ | p₃ | c | c |

The pulse coding differs when compared to 2 or 3 pulses/track solution above. The codebook mapper 294 however can extract from the bit stream the first two pulses in order to produce an approximated baseline signal. Table 7 shows which bits are selected from Table 6 to form the approximation.

TABLE 7
Selected bits for approximating 12.65 kbps decoding

| case | 0 | 1 | 2 | 3 | 4 | 5 | 6 | 7 | 8 |
|---|---|---|---|---|---|---|---|---|---|
| 0, 4 | c | c | s₀ | p₀ | p₀ | p₁ | p₁ | s_{b} | s_{c} |
| 1 | c | c | s₀ | p₀ | p₀ | p₁ | p₁ | s_{b} | |
| 2 | c | c | s₀ | p₀ | p₀ | p₀ | p₁ | p₁ | p₁ |
| 3 | c | c | s₁ | p₁ | p₁ | p₂ | p₂ | s_{b} | |

The information bits shown in Table 7 are not compliant with 12.65 kbps mode decoding, but provide the information needed for approximating the two pulse excitation from the four pulse mode of operation. Furthermore in cases 1 and 3 only eight bits are used and does not use all nine bits. Thus embodiments of the invention may allocate another bit from the bit stream for FEC protection. The info is not directly applied to decoding in case the remaining bits are unusable, i.e. there are errors in the other bits. Furthermore in embodiments as described above in case 3 situation the approximation applies to the second and the third pulses due to the quantisation.

Thus in the decoder as described below case information is used under FEC protection to distinguish the different quantisation schemes for the pulse combinations.

In some embodiments of the invention the mapping of information in Table 7 is further processed to produce a baseline (12.65 kbps) compatible format. This embodiment process produces a bit format according to Table 8. The subsection and section info bits are applied as most significant bits to drive the pulses in correct places in each track. The case information in this arrangement is not used in the bit field.

TABLE 8
12.65 kbps mode compatible decoding

| case | 0 | 1 | 2 | 3 | 4 | 5 | 6 | 7 | 8 |
|---|---|---|---|---|---|---|---|---|---|
| 0, 4 | s_{c} | s_{b} | p₁ | p₁ | s_{c} | s_{b} | p₀ | p₀ | s₀ |
| 1 | 1 | s_{b} | p₁ | p₁ | 1 | s_{b} | p₀ | p₀ | s₁ |
| 2 | 0 | p₁ | p₁ | p₁ | 0 | p₀ | p₀ | p₀ | s₀ |
| 3 | 0 | s_{b} | p₂ | p₂ | 0 | s_{b} | p₁ | p₁ | s₁ |

If five pulses per track are determined, the 5 signed pulses in a track of length K=2^{M} can be encoded using 5M bits. The K positions in the track are divided into 2 sections A and B. Each of the sections can contain from 0 to 5 pulses. To encode the 5 pulses the method identifies a section that contains at least 3 pulses and encodes the 3 pulses in that section using 3(M−1)+1=3M−2 bits, and encodes the remaining 2 pulses in the whole track using 2M+1 bits. This produces a code with 5M−1 bits. An extra bit identifies which section contains the at least 3 pulses. Thus a total of 5M bits are used to encode the 5 signed pulses.

The index of the 5 signed pulses is given by

I₅ₚ=I₂ₚ+I₃ₚ×2^{2M}+k×2^{5M-1}

Where k is the index of the section that contains at least 3 pulses, I₃ₚ is the index of the 3 pulses in that section (3(M−1)+1 bits), and I₂ₚ is the index of the remaining 2 pulses in the track (2M+1 bits).

Table 9 presents the corresponding bit field.

TABLE 9
Bit field for 5 pulses/track combination

| 0 | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|
| S₀ | p₀ | p₀ | p₁ | p₁ | s_{b} | s₁ | p₂ | p₂ | P₂ | s_{c} | s₃ | p₃ | p₃ | p₃ | p₃ | p₄ | p₄ | p₄ | p₄ |

The codebook mapper 294 in a first embodiment of the invention selects the last two pulses that are coded for the full track to produce an approximation of the two pulse per track baseline coding mode. The number of bits used by selecting the last two pulses is 9 bits, which enables a mapping to a baseline (12.65 kbps) compatible decoding format.

Thus in embodiments of the invention the codebook mapper 294 furthermore performs an additional operation on the approximation of the two pulse per track baseline mode as can be shown by Table 10. The embodiment therefore produces a format which is compatible to the 12.65 kbps mode fixed codebook.

TABLE 10
2 pulses/track mapped for approximating 12.65 kbps decoding

| 0 | 1 | 2 | 3 | 4 | 5 | 6 | 7 | 8 |
|---|---|---|---|---|---|---|---|---|
| p₄ | p₄ | p₄ | p₄ | p₃ | p₃ | p₃ | p₃ | s₃ |

In the 6 pulse per track mode of operation, the 6 signed pulses in a track of length K=2^{M} are encoded using 6M−2 bits. The K positions in the track are divided into 2 sections A and B. Each of these sections may contain from 0 to 6 pulses. Table 1 11 shows the 7 possible arrangements or cases representing the number of pulses in each section:

TABLE 11
Possible pulse combinations in subframe sections

| | Pulses in Section | Pulses in Section | Bits |
|---|---|---|---|
| case | A | B | needed |
| 0 | 0 | 6 | 6M-5 |
| 1 | 1 | 5 | 6M-5 |
| 2 | 2 | 4 | 6M-5 |
| 3 | 3 | 3 | 6M-4 |
| 4 | 4 | 2 | 6M-5 |
| 5 | 5 | 1 | 6M-5 |
| 6 | 6 | 0 | 6M-5 |

As can be seen from the table it is possible to pair the cases 0 and 6, 1 and 5, and 2 and 4, as they are differ only in having to determine which of the two sections have the greater number of pulses. These cases can be coupled and an extra bit can be assigned to identify which section contains the greater number of pulses. These cases need 6M−5 bits to encode the position of the pulses, which with the additional bit to identify which section has the greater number of pulses thus uses 6M−4 bits. This arrangement uses 2 further bits to define which of the 4 remaining grouped cases (i.e. which of the groups (0,6), (1,5), (2,4), and (3)) is being coded. This gives a total of 6M−4+2=6M−2 bits to define the 6 signed pulses.

For cases 0 and 6, 1 bit is used to identify the section which contains 6 pulses. 5 pulses in that section are encoded using 5(M−1) bits (since the pulses are confined to that section), and the remaining pulse is encoded using (M−1)+1 bits. Thus a total of 1+5(M−1)+M=6M−4 bits are used for this coupled case. An extra 2 bits are used to encode the state of the coupled case, giving a total of 6M−2 bits. For this coupled case, the index of the 6 pulses is given by

I₆ₚ=I₁ₚ+I₅ₚ×2^{M}+j×2^{6M-5}+k×2^{6M-4}

where k is the index of the coupled case (2 bits), j is the index of the section containing 6 pulses (1 bit), I₅ₚ is the index of 5 pulses in that section (5(M−1) bits), and I₁ₚ is the index of the remaining pulse in that section ((M−1)+1 bits).

For cases 1 and 5, 1 bit is used to identify the section which contains 5 pulses. The 5 pulses in that section are encoded using 5(M−1) bits and the pulse in the other section is encoded using (M−1)+1 bits. For this coupled case, the index of the 6 pulses is given by

I₆ₚ=I₁ₚ+I₅ₚ×2^{M}+j×2^{6M-5}+k×2^{6M-4}

where k is the index of the coupled case (2 bits), j is the index of the section containing 5 pulses (1 bit), I₅ₚ is the index of the 5 pulses in that section (5(M−1) bits), and I₁ₚ is the index of the pulse in the other section ((M−1)+1 bits).

For cases 2 or 4, 1 bit is used to identify the section which contains 4 pulses. The 4 pulses in that section are encoded using 4(M−1) bits and the 2 pulses in the other section are encoded using 2(M−1)+1 bits. For this coupled case, the index of the 6 pulses is given by

I₆ₚ=I₂ₚ+I₄ₚ×2^{2(M-1)+1}+j×2^{6M-5}+k×2^{6M-4}

where k is the index of the coupled case (2 bits), j is the index of the section containing 4 pulses (1 bit), I₄ₚ is the index of 4 pulses in that section (4(M−1) bits), and I₂ₚ is the index of the 2 pulses in the other section (2(M−1)+1 bits).

For case 3, the 3 pulses in each section are encoded using 3(M−1)+1 bits in each Section. For this case, the index of the 6 pulses is given by

I₆ₚ=I_{3pB}+I_{3pA}×2^{3(M-1)+1}+k×2^{6M-4}

where k is the index of the coupled case (2 bits), I_{3pB} is the index of 3 pulses Section B (3(M−1)+1 bits), and I_{3pA} is the index of the 3 pulses in Section A (3(M−1)+1 bits).

The coding structure for all seven case pulse combinations is shown in Table 12.

TABLE 12
Bit field options for 6 pulses/track combination

| Case | 0 | 1 | 2 | 3 | 4 | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|---|---|---|---|---|
| 0, 6 | s_{c} | s₀ | p₀ | p₀ | p₁ | p₁ | s_{b} | s₁ | p₂ | p₂ | s₂ | p₃ | p₃ | p₄ | p₄ | s₃ | p₅ | p₅ | p₅ | j | k | k |
| 1, 5 | s_{c} | s₀ | p₀ | p₀ | p₁ | p₁ | s_{b} | s₁ | p₂ | p₂ | s₂ | p₃ | p₃ | p₄ | p₄ | s₃ | p₅ | p₅ | p₅ | j | k | k |
| 2, 4 | s₀ | p₀ | p₀ | p₁ | p₁ | s_{b} | s₁ | p₂ | p₂ | s₂ | p₃ | p₃ | s₃ | p₄ | p₄ | p₄ | p₅ | p₅ | p₅ | j | k | k |
| 3 | s₀ | p₀ | p₀ | p₁ | p₁ | s_{b} | s₁ | p₂ | p₂ | p₂ | s₂ | p₃ | p₃ | p₄ | p₄ | s_{b} | s₄ | p₅ | p₅ | p₅ | k | k |

Two pulses are extracted from the bit stream for every combination in order to produce the approximation of the two pulse per track baseline coding. The codebook mapper 294 in embodiments of the invention selects the bits from the structure shown in Table 12 to produce the structure shown in Table 13. The structure based on the case 3 structure does not utilise all the bits. As described above the bit field for FEC can be completed by using any other bit from the frame. However the selected additional bit cannot be used in the decoder if the frame outside FEC protection contains some bit errors.

TABLE 13
Selected bits for approximating 12.65 kbps decoding

| Case | 0 | 1 | 2 | 3 | 4 | 5 | 6 | 7 | 8 |
|---|---|---|---|---|---|---|---|---|---|
| 0, 6 | s_{c} | s₂ | p₃ | p₃ | p₄ | p₄ | j | k | k |
| 1, 5 | s_{c} | s₂ | p₃ | p₃ | p₄ | p₄ | j | k | k |
| 2, 4 | s₀ | p₀ | p₀ | p₁ | p₁ | s_{b} | j | k | k |
| 3 | s₀ | p₀ | p₀ | p₁ | p₁ | s_{b} | k | k | |

The section and subsection bits are used as the most significant bits for each pulse position. Thus in embodiments of the invention in case 3 the first half of the track is selected. In some embodiments of the invention the codebook mapper further operates to convert the above structure into one fully compatible to the baseline bit structure. Table 14 shows a reconfigured bit stream structure which may be used as a structure compatible to the baseline (12.65 kbps) mode fixed codebook.

TABLE 14
2 pulses/track mapped for approximating 12.65 kbps decoding

| Case | 0 | 1 | 2 | 3 | 4 | 5 | 6 | 7 | 8 |
|---|---|---|---|---|---|---|---|---|---|
| 0, 6 | j | s_{c} | p₄ | p₄ | j | s_{c} | p₃ | p₃ | s₂ |
| 1, 5 | j | s_{c} | p₄ | p₄ | j | s_{c} | p₃ | p₃ | s₂ |
| 2, 4 | j | s_{b} | p₁ | p₁ | j | s_{b} | p₀ | p₀ | s₀ |
| 3 | 0 | s_{b} | p₁ | p₁ | 0 | s_{b} | p₀ | p₀ | s₀ |

The output of both the codebook mapper 294 and also the parametric coder output 201 are passed to the forward error correction (FEC) generator 223.

The FEC generator 223 generates an FEC source matrix from a subset of, exactly one, or more than one approximated 12.65-kbps speech frames—in other words from a FEC matrix is generated in embodiments of the invention from the received parametric coding and approximated residual coding combined. An originator may for example be included in or associated with a speech encoder, file composer, sender (such as a streaming server), or a media gateway. Furthermore, an originator calculates FEC repair data over the FEC source matrix.

The generation of FEC codes may be carried out by using any of the known linear block code FEC coding techniques.

The FEC generator outputs the FEC codes including the parity check bits to a multiplexer 225. Furthermore, the multiplexer 225 may receive further coding layers along connection 226 which have not been passed through the FEC generator. These may typically comprise, but not limited to, higher coding layers which may be outside the coverage of the FEC generator matrix. The multiplexer 225 then combines the codes to form a single output data stream which may be stored or transmitted.

Further embodiments of the present invention may use a Convolutional type coding scheme where the output of the FEC generator matrix may be a code word comprising the parity check bits. In this case the parametric and residual codes may be applied to the same or different generator matrices, thereby providing two individual code words to be multiplexed together by the multiplexer, 225. Also, further embodiments may apply both the residual and parametric codes as a single source to the FEC generator matrix, whereby the, multiplexer, 225, may in this instance multiplex FEC protected and non FEC protected streams.

In some embodiments of the invention the multiplexer interleaves the data to produce an interleaved data stream.

In other embodiments of the invention the multiplexer multiplexes the parametric and residual codes only and outputs a combined parametric and residual data stream and a separate forward error correction data stream.

The multiplexer 225 outputs a multiplexed signal which may then be transmitted or stored.

This multiplexing is shown in FIG. 3 by step 313.

The output from the error coder 290 may therefore in some instances be the original encoded speech frames and the FEC code data. Further side information enabling a receiver to reconstruct the FEC source matrix may also be transmitted or stored. In some embodiments of the invention the side information may be transmitted within the m=fmtp line of a Session Description Protocol (SDP).

In some embodiments the FEC code data is stored for later transmission where the repair data may reside in hint samples of a hint track of a file derived according to an ISO base media file format.

As described previously any FEC method employing such methods improves on the known FEC methods as the FEC coding protects at least partially the residual coding within a pre-defined way where at least an approximation of the baseline mode can be reconstructed irrespective of the original encoding of the residual component of the audio signal.

With respect to FIGS. 4a and 4b, an example of a decoder 400 for the codec implementing embodiments of the invention is shown. The decoder 400 may receive the encoded signal (residual and parametric code), parity check code and any necessary side information and outputs a reconstructed audio output signal. The operation of the decoder is furthermore shown and described below with respect to FIGS. 5a and 5b.

The decoder comprises an error decoder 401, which receives the encoded signal and outputs a series of data streams.

The error decoder 401 receives the encoded signal, shown in FIGS. 5a and 5b by step 501. The overall operation of the error decoder 401 is shown in FIG. 5a by step 503 and is shown in further detail in FIG. 5b by the operation of steps 1501 to 1513.

As shown in FIG. 4b the error decoder 401 comprises a demultiplexer 1401 which receives an input of the combined parametric, residual, forward error codes and any side information required to assist in the decoding of the forward error codes. It is to be understood that the de-multiplexer may receive the input stream as scalable coding layers, and during the course of transmission or as part of the storage process there may be smaller number of layers received than was originally encoded.

In some embodiments of the present invention the forward error codes (and any side information) are passed to a FEC decoder 1407 together with the residual and parametric codes. In further embodiments such as those that employ a convolutional type of forward error coding scheme, the data passed to the FEC decoder 1407 may comprise codewords consisting of both source data and parity check bits.

The demultiplexing of the signals is shown in FIG. 5b by step 1501.

The FEC decoder then generates a FEC source matrix using the baseline (or core) coded speech frames, and error codes. Therefore the FEC code is decoded and checked against the mapped residual code and parametric codes to determine if the mapped residual code or parametric code is missing or corrupted.

This detection operation is shown in FIG. 5b by step 1505.

If the FEC decoder 1407 determines that any speech frame contains lost or corrupted data, the missing data in the FEC source matrix can be recovered using the received FEC repair (code) data provided that the correction capability of the received FEC repair data is sufficient compared to the amount of lost or corrupted data in the FEC source matrix.

Thus the correction of the parametric code is shown in FIG. 5b by step 1507. The corrected parametric code is shown to be output in FIG. 5b by step 1509.

The correction of the baseline residual code is shown in FIG. 5b by step 1511. The mapped code where corrected is included in the complete residual code and output as shown in FIG. 5b by step 1513.

The error decoder 401 is connected to a parametric decoder 471 for passing the corrected parametric code or lower level bitstreams. The error decoder/demultiplexer 401 is also connected to a residual decoder 473 for outputting the corrected residual code or higher level bitstreams

The decoding of the corrected parametric code signal is shown in FIG. 5a in step 505. This step may typically comprise de-quantising process where the indices of the quantised received coded parameters are converted back to their quantised values. These parameters may then be transformed back to the parametric model filter coefficient domain, which may typically be in the form LPC or reflection coefficients.

The residual decoder 473 after receiving the corrected residual codes performs a residual code decoding process to form the approximation of the difference signal originally formed in the encoder. This may typically take the form of decoding the secondary fixed (codebook) excitation indices and gain, in order to form the fixed excitation vector. Further, the residual decoding step may also include decoding the parameters of the LTP adaptive codebook stage, in order to generate a further excitation vector. Typically these two excitation vectors may be combined in an additive manner in order to derive a further form of the excitation vector.

This residual code decoding process is shown in FIG. 5a in step 507.

The output from step 505, i.e. the decoded parametric model coefficients may then be used in step 509 in FIG. 5a, as the coefficients of the parametric model filter 475. Typically, but not limited to, this filter may take the form of a LPC synthesis filter structure. However further embodiments of the present invention may adopt a lattice filter structure. The excitation vector, from the Residual decoding process 473, may then be used as input to this parametric filter model. The process of generating the time domain speech/audio signal from the parametric filter model is depicted in step 509.

Finally the reconstructed signal may be output as shown in FIG. 5a in step 511.

Advantages associated with the invention are that having the partial FEC scheme in place the receiver is always able to reconstruct at least the lowest protected codec mode from the received and decoded bit stream. When the frame is received error free, the remaining part of the bit stream having less or no protection at all could be applied to enhance the decoding and reconstruct the higher bit rate mode.

The above described a procedure using the example of the AMR-WB speech codec. However, similar principles can be applied to any other speech or audio codec.

The embodiments of the invention described above describe the codec in terms of separate encoders 200 and decoders 400 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 110, it would be appreciated that the invention as described below may be implemented as part of any variable rate/adaptive rate audio (or speech) codec. Thus, for example, embodiments of the invention may be implemented in an audio codec which may implement audio coding over fixed or wireless communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-66. (canceled)

67. A method comprising:
receiving an first signal
generating a second signal based on the first signal;
generating an encoded residual signal based on the second signal and the first signal, wherein the encoded residual signal comprises at least one time varying filter excitation vector index associated with a time varying filter excitation vector from a time varying filter excitation stage;
partitioning the encoded residual signal into at least two parts by dividing the at least one time varying filter excitation vector into at least two excitation vector sub indices, wherein each of said at least two excitation vector sub indices are associated with one set of excitation vector components, wherein the at least one time varying filter excitation vector comprises at least two sets of excitation vector components, and wherein the partitioned encoded residual signal comprises the at least two excitation vector sub-indices; and
combining at least one part of the encoded residual signal and the second signal to output an encoded signal.

68. The method as claimed in claim 67, wherein the second signal comprises at least one parametric model coefficient.

69. The method as claimed in claim 67, wherein the time varying filter excitation stage is a fixed codebook excitation stage comprising the at least one time varying filter excitation vector, each time varying filter excitation vector is a fixed codebook excitation vector, and each excitation vector index is a codebook excitation vector index.

70. The method as claimed in claim 69, wherein the fixed codebook excitation vector is a sparsely populated excitation vector, and each set of the at least two sets of vector components of the said fixed codebook excitation vector are mutually exclusive.

71. The method as claimed in claim 70, wherein the codebook excitation vector index comprises a coded excitation vector comprising at least one coded time domain pulse.

72. The method as claimed in claim 71, further comprising:
reindexing the coded time domain pulses based on a codebook position rule.

73. The method as claimed in claim 72, the codebook position rule comprising:
defining a codebook structure based on interleaved single pulse permutation design,
dividing positions of codebook parameters into at least two tracks of predetermined interleaved positions, wherein each of said at least two tracks comprises at least two coded time domain pulses;
identifying a plurality of bits associated with each one of the at least two coded time domain pulses within at least one of the at least two tracks;
arranging the plurality of bits into at least one time domain coded pulse index; and
concatenating each of the at least one time domain coded pulse index into a second codebook excitation index,
wherein the at least one time domain coded pulse index comprises information relating to the position and sign of the coded time domain pulse within the at least two tracks.

74. The method as claimed in claim 67, wherein the time varying filter comprises a Linear Predictive Coding (LPC) filter, and wherein the time varying filter coefficients comprise Linear Predictive Coding coefficients.

75. The method as claimed in claim 67, further comprising generating forward error codes for the second signal and at least one part of the at least two parts of the encoded residual signal.

76. An apparatus comprising
at least one processor and at least one memory including computer program code, the at least one memory and the computer program code configured to, with the at least one processor cause the apparatus at least to:
receive an first signal;
generate a second signal based on the first signal;
generate an encoded residual signal based on the second signal and the first signal, wherein the encoded residual signal comprises at least one time varying filter excitation vector index associated with a time varying filter excitation vector from a time varying filter excitation stage;
partition the encoded residual signal into at least two parts by dividing the at least one time varying filter excitation vector into at least two excitation vector sub indices, wherein each of said at least two excitation vector sub indices are associated with one set of excitation vector components, wherein the at least one time varying filter excitation vector comprises at least two sets of excitation vector components, and wherein the partitioned encoded residual signal comprises the at least two excitation vector sub-indices; and
combine at least one part of the encoded residual signal and the second signal to output an encoded signal.

77. The apparatus as claimed in claim76, wherein the second signal comprises at least one parametric model coefficient.

78. The apparatus as claimed in claim 76, wherein the time varying filter excitation stage is a fixed codebook excitation stage comprising the at least one time varying filter excitation vector, each time varying filter excitation vector is a fixed codebook excitation vector, and each excitation vector index is a codebook excitation vector index.

79. The apparatus as claimed in claim 76, wherein the fixed codebook excitation vector is a sparsely populated excitation vector, and each set of the at least two sets of vector components of the said fixed codebook excitation vector are mutually exclusive.

80. The apparatus as claimed in claim 79, wherein the codebook excitation vector index comprises a coded excitation vector comprising at least one coded time domain pulse.

81. The apparatus as claimed in claim 80, wherein the at least one memory and the computer program code is further configured to, with the at least one processor, further cause the apparatus at least to:
reindex the coded time domain pulses based on a codebook position rule.

82. The apparatus as claimed in claim 81, wherein the codebook position rule comprises:
defining a codebook structure based on interleaved single pulse permutation design,
dividing positions of codebook parameters into at least two tracks of predetermined interleaved positions, wherein each of said at least two tracks comprises at least two coded time domain pulses;
identifying a plurality of bits associated with each one of the at least two coded time domain pulses within at least one of the at least two tracks;
arranging the plurality of bits into at least one time domain coded pulse index; and
concatenating each of the at least one time domain coded pulse index into a second codebook excitation index,
wherein the at least one time domain coded pulse index comprises information relating to the position and sign of the coded time domain pulse within the at least two tracks.

83. The apparatus as claimed in claim 76, wherein the time varying filter comprises a Linear Predictive Coding (LPC) filter, and wherein the time varying filter coefficients comprise Linear Predictive Coding coefficients.

84. The apparatus as claimed in claim 76, wherein the at least one memory and the computer program code is further configured to, with the at least one processor, further cause the apparatus at least to:
generate forward error codes for the second signal and at least one part of the at least two parts of the encoded residual signal.

85. A method comprising:
receiving an encoded signal;
partitioning the encoded signal to generate at least a first part and a second part of the encoded signal, wherein the second part of the encoded signal comprises at least a first portion and a second portion; and
generating a combined second part signal dependent at least on the first portion of the second part of the encoded signal.

86. The method as claimed in claim 85, further comprising:
generating a corrected first part of the encoded signal;
generating a corrected first portion of the second part of the encoded audio signal;
generating a corrected second portion of the second part of the encoded audio signal; and
combining the corrected first part of the encoded signal, the corrected first portion of the second part of the encoded audio signal and the corrected second portion of the second part of the encoded audio signal.

87. The method as claimed in claim 85, further comprising:
decoding the combined second part signal to generate a decoded second part of the encoded signal, wherein the decoding the combined second part signal comprises residual decoding and the decoded second part of the encoded signal is at least one residual signal.

88. The method as claimed in claim 86, further comprising decoding the corrected first part of the encoded signal to generate a decoded first part of the encoded signal, wherein decoding the corrected first part of the encoded signal is a parametric decoding, and the decoded first part of the encoded signal is at least one parametric coefficient.

89. The method as claimed in claim 88, further comprising decoding the decoded first part of the encoded signal and the decoded combined second part of the encoded signal to generate the decoded audio signal dependent on the decoded first part of the encoded signal and the decoded second part of the encoded signal, wherein the decoding the decoded first part of the encoded signal and the decoded combined second part of the encoded signal is a parametric filtering, and wherein at least one coefficient of the parametric filter is defined by the decoded first part of the encoded signal, and the input to the parametric filter is the decoded combined second part of the encoded signal.

90. An apparatus comprising
at least one processor and at least one memory including computer program code, the at least one memory and the computer program code configured to, with the at least one processor cause the apparatus at least to:
receive an encoded signal;
partition the encoded signal to generate at least a first part and a second part of the encoded signal, wherein the second part of the encoded signal comprises at least a first portion and a second portion; and
generate a combined second part signal dependent at least on the first portion of the second part of the encoded signal.

91. The apparatus as claimed in claim 90, wherein the at least one memory and the computer program code is further configured to, with the at least one processor, further cause the apparatus at least to:
generate a corrected first part of the encoded signal;
generate a corrected first portion of the second part of the encoded audio signal;
generate a corrected second portion of the second part of the encoded audio signal; and
combine the corrected first part of the encoded signal, the corrected first portion of the second part of the encoded audio signal and the corrected second portion of the second part of the encoded audio signal.

92. The apparatus as claimed in claim 90, wherein the at least one memory and the computer program code is further configured to, with the at least one processor, further cause the apparatus at least to:
decode the combined second part signal to generate a decoded second part of the encoded signal, wherein the decoding the combined second part signal comprises residual decoding and the decoded second part of the encoded signal is at least one residual signal.

93. The apparatus as claimed in claim 91, wherein the at least one memory and the computer program code is further configured to, with the at least one processor, further cause the apparatus at least to:
decode the corrected first part of the encoded signal to generate a decoded first part of the encoded signal, wherein decoding the corrected first part of the encoded signal is a parametric decoding, and the decoded first part of the encoded signal is at least one parametric coefficient.

94. The apparatus as claimed in claim 93, wherein the at least one memory and the computer program code is further configured to, with the at least one processor, further cause the apparatus at least to:
decode the decoded first part of the encoded signal and the decoded combined second part of the encoded signal to generate the decoded audio signal dependent on the decoded first part of the encoded signal and the decoded second part of the encoded signal, wherein the decoding the decoded first part of the encoded signal and the decoded combined second part of the encoded signal is a parametric filtering, and wherein at least one coefficient of the parametric filter is defined by the decoded first part of the encoded signal, and the input to the parametric filter is the decoded combined second part of the encoded signal.
